(19) United States
(12) Patent Application Publication
(10) Pub. No.: US 2021/0084948 A1
(43) Pub. Date: Mar. 25, 2021

(54) SAVOURY CONCENTRATE

(71) Applicant: Conopco Inc., d/b/a UNILEVER, Englewood Cliffs, NJ (US)

(72) Inventors: Hendrikus Theodorus Wilhelmus Maria van der Hijden, Vlaardingen (NL); Marc Lemmers, Vlaardingen (NL); Robert Vreeker, Vlaardingen (NL)

(73) Assignee: Conopco Inc., d/b/a UNILEVER, Englewood Cliffs, NJ (US)

(21) Appl. No.: 16/498,434

(22) PCT Filed: Mar. 26, 2018
(86) PCT No.: PCT/EP2018/057573

§ 371 Date: Sep. 27, 2019

(30) Foreign Application Priority Data
Apr. 18, 2017 (EP) 17166738.9

(51) Int. Cl. A23L 23/10; A23L 29/00; A23L 29/30; A23L 33/125; A23L 33/24; A23L 29/262; A23L 33/115

(52) U.S. Cl. CPC A23L 23/10; A23L 29/015; A23L 29/30; A23L 33/115; A23L 33/24; A23L 29/262; A23L 33/125

(57) ABSTRACT

The present invention relates to a savoury concentrate comprising:
a. at least 30 wt. %, by weight of the concentrate, of an oil phase comprising liquid oil;
b. 3-30 wt. %, by weight of the concentrate, of an edible salt;
c. 1-50 wt. %, by weight of the concentrate, of savoury taste giving ingredients;
d. up to 10 wt. %, by weight of the concentrate, of water; and
e. a fibrous preparation of delaminated cell wall material from plant tissue;
wherein the fibrous preparation is dispersed in the oil phase in a concentration of 0.1 to 10 wt. %, by weight of the combined weight of the liquid oil and the fibrous preparation.

The invention further relates to a method for the preparation of the savoury concentrate and to a process for preparing a ready-to-eat savoury product using the savoury concentrate.

### FIELD OF THE INVENTION

The present invention relates to savoury concentrates comprising oil, edible salt, savoury taste giving ingredients; fibrous preparation of delaminated cell wall material from plant tissue and optionally further ingredients. The invention further relates to a method for the preparation of said savoury concentrate and to a process for preparing a ready-to-eat savoury product using said savoury concentrate.

### BACKGROUND OF THE INVENTION

Savoury concentrates are well-known in the art. These concentrates provide a convenient way of preparing, for instance, a soup, a sauce or can be used as a seasoning for a dish. Examples of savoury concentrates include dry concentrates, such as dry soup and bouillon cubes, liquid concentrates such as condensed soups, concentrated sauces and gelled concentrates. Savoury concentrates in the form of pastes are also known. Savoury concentrates are usually combined with hot water and optionally further food ingredients, such as vegetables or a protein source, to prepare a ready-to-eat savoury product (e.g. a bouillon, a soup, a sauce or a gravy).

WO 2017/021070 describes a savoury concentrate comprising the following components:
a) 22-85 wt. % inorganic salt;
b) 2-60 wt. % fat;
c) 0.8-8 wt. % of carboxymethyl cellulose;
d) 0-25 wt. % of glutamate component selected from glutamic acid, edible glutamate salts and combinations thereof;
e) 0-25 w.% starch component selected from native starch, pregelatinised starch, maltodextrin, modified starch and combinations thereof;
f) 0-20 wt. % of sugar selected from monosaccharides, disaccharides and combinations thereof;
g) 0-45 wt. % of vegetable matter selected from vegetables, herbs, spices and combinations thereof;
h) 0-10 wt. % water;
wherein the components a) to e) together constitute at least 55 wt. % of the savoury concentrate and wherein the components a) to h) together constitute at least 75 wt. % of the savoury concentrate.

Savoury concentrates typically have a shelf-life of several months at ambient temperature. Savoury concentrates that comprise high levels of liquid oil, such as vegetable oil, tend to show oil exudation during storage over time. Oil exudation results in the formation of an oily layer within the product package. This renders the product unattractive and may even cause consumers to reject the product.

Oil exudation in savoury concentrates can be minimized by mixing liquid oil with a high melting fat component. Examples of such high melting fat components are hydrogenated vegetable oils (e.g. fully hydrogenated rapeseed oil) or high melting palm oil fractions (palm stearins). However, these high melting fat components, unlike the liquid oil, contain high levels of saturated fatty acids. Fats that contain high levels of saturated fatty acids are generally regarded as less healthy than liquid oils that contain high levels of unsaturated fatty acids.

In addition, if these savoury concentrates with high melting fats are transported in tropical countries in trucks without temperature control, the temperature within the truck may easily rise far above the melting temperature of the high melting fats, which affects the stability of the savoury concentrates, e.g. undesired layers are formed in the savoury concentrate.

Therefore there is a clear consumer need to obtain a stable savoury concentrate for the preparation of e.g. sauces, which contains a high level of liquid oil, but does not suffer from oil exudation or undesired layer formation.

A plant cell wall is arranged in layers and contains cellulose, hemicellulose, pectin, lignin, and soluble protein. These components are organized into three major layers: the primary cell wall, the secondary cell wall and the middle lamella. The cell wall surrounds the plasma membrane and provides the cell tensile strength and protection.

During cell wall formation cellulose polymers arrange in elementary fibrils immediately after their synthesis in the cell membrane. These elementary fibrils with a typical diameter of 3-3.5 nm contain on average of 36 cellulose polymer chains and can assemble into thicker fibrillar structures (e.g. microfibrils and fibrils) with a diameter of 3-70 nanometers and have a length that can vary within a wide range, but usually measures several micrometers.

Microfibrillated cellulose, also referred to a nanofibrillated cellulose, is the term used to describe a material that is composed of cellulose microfibrils and/or elementary fibrils that have been isolated from plant cell walls. Microfibrillated cellulose can be obtained from plant cell walls by delaminating the cell walls, including the fibrillar structure of cellulose microfibrils. Such delamination of the plant cell walls can be achieved by applying high-pressure, high temperature and high velocity impact homogenization, grinding, cavitation or microfluidization.

WO 2015/128155 describes a preparation of plant parenchymal cell wall clusters, the cell wall clusters comprising at least 60 wt % of cell wall derived polysaccharides, the cell wall clusters having a
volumetric mass density of at least 0.1 gram/ml;
S_{BET} of at least 3 m²/gram; and
rehydrated particle size having a d(0.1) value higher than 20 micrometer and a d(0.9) value lower than 1 500 micrometer;

wherein the preparation comprises up to 20 wt % of water and has a water activity (Aw) of less than 0.5. These preparations can be used as a structurant in instant dry foods.

### SUMMARY OF THE INVENTION

The inventors of the present invention have developed a savoury concentrate that meets these consumer needs, i.e. a stable savoury concentrate for the preparation of e.g. sauces, which contains a high level of liquid oil, but does not suffer from oil exudation or undesired layer formation.

The inventors have unexpectedly found that oil exudation in savoury concentrates can be minimized effectively by introducing a fibrous preparation, of delaminated cell wall material from plant tissue, into the liquid oil component of the savoury concentrate. It was discovered that this fibrous preparation is capable of forming an oil-retaining matrix within the liquid oil component. Unlike high melting fat, the oil-structuring properties of the fibrous preparation is not affected by a temperature increase.

The presence of the fibrous preparation in the savoury concentrate has no adverse impact on the taste and mouthfeel of the ready-to-eat savoury products that are prepared from these concentrates.

Accordingly, the savoury concentrate according to the invention comprises:
a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) a fibrous preparation of delaminated cell wall material from plant tissue, said fibrous preparation comprising at least 25%, by weight of dry matter, of cellulose and having a BET specific surface area (S_{BET}) of at least 5 m²/g;

wherein the fibrous preparation is dispersed in the oil phase in a concentration of 0.1 to 10 wt. %, by weight of the combined weight of the liquid oil and the fibrous preparation.

The present invention further pertains to a method for the preparation of a savoury concentrate according to the invention, said method comprises the combining of the following components:
a. 100 parts by weight of an oil phase comprising liquid oil;
b. 0.1-10 parts by weight of a fibrous preparation of delaminated cell wall material from plant tissue, said fibrous preparation comprising at least 25%, by weight of dry matter, of cellulose and having a BET specific surface area (S_{BET}) of at least 5 m²/g;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof; and

wherein the prepared savoury concentrate comprises not more than 10 wt. % water.

The present invention further relates to a process of preparing a ready-to-eat savoury product, using the savoury concentrate according to the invention.

### DETAILED DESCRIPTION OF THE INVENTION

A first aspect of the invention relates to a savoury concentrate comprising:
a) at least 30 wt. %, by weight of the concentrate, of an oil phase comprising liquid oil;
b) 3-30 wt. %, by weight of the concentrate, of an edible salt selected from sodium chloride, potassium chloride and combinations thereof;
c) 1-50 wt. %, by weight of the concentrate, of savoury taste giving ingredients selected from glutamate, 5′-ribonucleotides, sucrose, glucose, fructose, lactic acid, citric acid and combinations thereof;
d) up to 10 wt. %, by weight of the concentrate, of water; and
e) a fibrous preparation of delaminated cell wall material from plant tissue, said delaminated cell wall material containing a reduced amount of water-soluble components and having a lamellar structure of the primary cell walls that has at least partly been disrupted to release cellulose microfibrils, and said fibrous preparation comprising at least 25%, by weight of dry matter, of cellulose and having a BET specific surface area (S_{BET}) of at least 5 m²/g;

wherein the fibrous preparation is dispersed in the oil phase in a concentration of 0.1 to 10 wt. %, by weight of the combined weight of the liquid oil and the fibrous preparation.

The word ‘comprising’ as used herein is intended to mean ‘including’ but not necessarily ‘consisting of’ or ‘composed of’. In other words, the listed steps or options need not be exhaustive.

Unless specified otherwise, numerical ranges expressed in the format ‘from x to y’ or ‘x-y’ are understood to include x and y. When for a specific feature multiple preferred ranges are described in the format ‘from x to y’ or ‘x-y’, it is understood that all ranges combining the different endpoints are also contemplated. For the purpose of the invention ambient temperature is defined as a temperature of about 20° C.

Unless indicated otherwise, weight percentages (wt. %) are based on the total weight of the concentrate.

The terms ‘fat’ or ‘oil’ are used interchangeably, unless specified otherwise. The terms ‘fat’ and ‘oil’ as used herein refers to glycerides selected from triglycerides, diglycerides, monoglycerides, phosphoglycerides, free fatty acids and combinations thereof. Where applicable the prefix ‘liquid’ or ‘solid’ is added to indicate whether the fat or oil is liquid or solid at 20° C. “Hard stock” is an example of a solid fat. Hard stock typically has a solid fat content at 20° C. (N₂₀) of at least 30%.

The solid fat content of the oil phase can suitably be determined using the method described in Animal and vegetable fats and oils—Determination of solid fat content by pulsed NMR—Part 1: Direct method—ISO 8292-1:2008.

The water content of the savoury concentrate refers to the total water content, thus including the water that is present within the ingredients of the savoury concentrate.

The term ‘fibrous preparation’ as used herein refers to a composition that has been isolated from plant cell walls and that is rich in cellulosic fibres that are naturally present in these plant cell walls. The fibrous preparation is preferably essentially anhydrous and preferably contains not more than 10 wt. % of water.

The term ‘cell wall material’ as used herein refers to plant cell wall material from which water soluble components (e.g. pectin, sugars and minerals) have been removed, e.g. by washing the cell wall material with water.

The term ‘delaminated cell wall material’ as used herein refers to cell wall material in which at least a part of the lamellar structure of the primary cell walls has been disrupted to release cellulose microfibrils.

The term ‘cellulose’ as used herein refers to a polysaccharide with the formula (C₆H₁₀O₅)ₙ, consisting of a linear chain of β(1→4) linked D-glucose units.

The ‘microfibril’ as used herein refers to parallel arrays of cellulose elementary fibrils. A cellulose elementary fibril typically includes a strand of about 36 cellulose polymers. The individual cellulose polymers are bound together in the elementary fibril by hydrogen bonds.

The term ‘fibril’ as used herein refers to arrays of microfibrils.

The term ‘defibrillated’ as used herein refers to the disentanglement of cellulose fibrils and microfibrils to release cellulose microfibrils and elementary fibrils, respectively.

The term ‘pectin’ as used herein refers to polysaccharides that are rich in galacturonic acid, including:
Homogalacturonans: linear chains of α-(1-4)-linked D-galacturonic acid;
Substituted galacturonans: containing saccharide appendant residues (such as D-xylose or D-apiose in the respective cases of xylogalacturonan and apiogalacturonan) branching from a backbone of D-galacturonic acid residues;
Rhamnogalacturonan I pectins: containing a backbone of the repeating disaccharide: 4)-α-D-galacturonic acid-(1,2)-α-L-rhamnose-(1. From many of the rhamnose residues, sidechains of various neutral sugars branch off. The neutral sugars are mainly D-galactose, L-arabinose and D-xylose, with the types and proportions of neutral sugars varying with the origin of pectin
Rhamnogalacturonan II: a highly branched polysaccharide. Rhamnogalacturonan II is classified by some authors within the group of substituted galacturonans since the rhamnogalacturonan II backbone is made exclusively of D-galacturonic acid units.

The term ‘S_{BET}’ as used herein refers to the specific surface area as determined from adsorption/desorption isotherms, based on the Brunauer-Emmett-Teller (BET) theory and using nitrogen (N₂) as the sample gas [see e.g. S. J. Gregg, K. S. W. Sing, Adsorption, Surface area and Porosity, 2^{nd} ed. Academic Press, London, 1982].

The ‘oil exudation’ can suitably be quantified by means of the method as explained below in the examples. An amount of free oil of not more than 1 wt. %, preferably not more than 0.5 wt. %, by weight of the total savoury concentrate, is considered to be acceptable.

Savoury Concentrate

The savoury concentrate according to invention is preferably in solid form or in the form of a paste. More preferably the savoury concentrate is in the form of a paste, i.e. a very thick viscous fluid.

The savoury concentrate preferably comprises, by weight of the concentrate, 33-75 wt. % of the oil phase, more preferably 36-70 wt. % of the oil phase and most preferably 40-65 wt. %, of the oil phase.

Preferably, the oil phase has a solid fat content at 20° C. (N₂₀) of 0-15% and a liquid oil content at 20° C. that equals 100%—N₂₀.

The oil phase in the savoury concentrate more preferably has a solid fat content at 20° C. (N₂₀) of less than 10%, even more preferably a N₂₀ of less than 5% and most preferably a N₂₀ of 0%.

The oil phase in the savoury concentrate preferably has a solid fat content at 35° C. (N₃₅) of less than 5%, more preferably a N₃₅ of less than 3% and most preferably a N₃₅ of 0%.

Preferably, the oil phase contains at least 30 wt. % of vegetable oil, more preferably at least 50 wt. % of vegetable oil, even more preferably 70 wt. % of vegetable oil and most preferably the oil phase contains at least 90 wt. % of vegetable oil. Examples of vegetable oils that may be employed include sunflower oil, soybean oil, rapeseed oil, cottonseed oil, maize oil, olive oil, palm oil, palm kernel oil, coconut oil, fractions of these oils and combinations thereof.

The oil phase of the present invention preferably does not comprise hydrogenated fat.

The savoury concentrate preferably comprises, by weight of the concentrate, 5-25 wt. %, more preferably 8-20 wt. %, of the edible salt, selected from sodium chloride, potassium chloride and combinations thereof. Preferably the edible salt is sodium chloride.

The savoury concentrate preferably comprises, by weight of the concentrate, 5-40 wt. %, preferably 10-30 wt. %, of the savoury taste giving ingredients, selected from glutamate, 5′-ribonucleotides, sucrose, glucose, fructose, lactic acid, citric acid and combinations thereof.

Preferably, these savoury taste giving ingredients may be added as such or as part of a more complex ingredient like a yeast extract, meat extract, plant extract or a fish extract.

The savoury concentrate preferably comprises, by weight of the concentrate, up to 9 wt. % of water, more preferably up to 8 wt. % of water.

Preferably, the fibrous preparation is dispersed in the oil phase in a concentration of 0.2 to 8 wt. %, more preferably 0.3-6 wt. %, most preferably 0.5-4 wt. %, by weight of the combined weight of the liquid oil and the fibrous preparation.

The “wt. % of the fibrous preparation, by weight of the combined weight of the liquid oil and the fibrous preparation”, as used herein, is calculated by dividing: [100×the weight of the fibrous preparation] by: [weight of the liquid oil+weight of the fibrous preparation].

Preferably, the oil phase is a structured oil phase due to the presence of the fibrous preparation.

The inventors have found that the fibrous preparation can take over the structuring function of the high melting fat component that is typically applied in such savoury concentrates to prevent oil exudation. The high melting fat component and the fibrous preparation can be used in combination to structure the liquid oil component of the savoury concentrate.

Typically, the sum of (i) the wt. % of the fibrous preparation, by weight of the combined weight of the liquid oil and the fibrous preparation, and (ii) the percentage of solid fat content in the oil phase at 20° C. (N₂₀), lies within the range of 1-20, more preferably this sum lies within the range of 1.5-17, even more preferably within the range of 2-15, yet even more preferably within the range of 2.5-13 and most preferably this sum lies within the range of 3-11.

Preferably, the components a) to e) of the savoury concentrate together constitute at least 60 wt. % of the savoury concentrate. More preferably, the components a) to e) of the savoury concentrate together constitute at least 65 wt. % of the savoury concentrate. Most preferably, the components a) to e) of the savoury concentrate together constitute at least 70 wt. % of the savoury concentrate.

The ratio of dry matter by weight to the oil phase, by weight in the savoury concentrate, lies within the range of 2:1 to 0.2:1. More preferably, said weight ratio in the savoury concentrate lies within the range of 1.8 to 0.5:1.

The savoury concentrate preferably has a water activity (A_{w}) within the range of 0.15-0.6, more preferably within the range of 0.2-0.55 and most preferably within the range of 0.25-0.50.

The savoury concentrate preferably comprises, by weight of the concentrate, not more than 25 wt. % of sugars selected from sucrose, glucose, fructose and combinations thereof. More preferably, the savoury concentrate comprises, by weight of the concentrate, not more than 20 wt. % of said sugars.

The savoury concentrate preferably comprises, by weight of the concentrate, 0.1-50 wt. % of particulate plant material selected from herbs, spices, vegetables and combinations thereof. More preferably, the savoury concentrate comprises, by weight of the concentrate 1-40 wt. % of said particulate plant material and most preferably 5-35 wt. % of said particulate plant material.

Preferably, the particulate plant material has a mass weighted average diameter in the range of 50 to 3,000 μm, more preferably in the range of 80 to 1,000 μm and most preferably in the range of 100 to 500 μm.

In a particularly preferred embodiment, the savoury concentrate comprises:
a) 40-65 wt. %, by weight of the concentrate, of the oil phase having a solid fat content at 20° C. (N₂₀) of 0-5% and a liquid oil content at 20° C. that equals 100%—N₂₀;
b) 8-20 wt. %, by weight of the concentrate, of an edible salt selected from sodium chloride, potassium chloride and combinations thereof;
c) 10-30 wt. %, by weight of the concentrate, of savoury taste giving ingredients selected from glutamate, 5′-ribonucleotides, sucrose, glucose, fructose, lactic acid, citric acid and combinations thereof;
d) up to 8 wt. %, by weight of the concentrate, of water;
e) the fibrous preparation; and
f) 5-35 wt. %, by weight of the concentrate, of particulate plant material selected from herbs, spices, vegetables and combinations thereof;
wherein the fibrous preparation is dispersed in the oil phase in a concentration of 0.5 to 4 wt. %, by weight of the combined weight of the liquid oil and the fibrous preparation; and
wherein the sum of (i) the wt. % of the fibrous preparation, by weight of the combined weight of the liquid oil and the fibrous preparation, and (ii) the percentage of solid fat content in the oil phase at 20° C. (N₂₀), lies within the range of 3-11.

Cell Wall Material

The cell wall is a protective layer that is formed by typical plant cells and surrounds the cell membrane. A plant cell wall typically contains cellulose, hemicellulose, pectin and optionally lignin. This contrasts with the cell walls of fungi (which are made of chitin), and of bacteria, which are made of peptidoglycan. The cell wall might be considered as a composite material, made of fibre (cellulose), a matrix (lignin, hemicellulose, pectin) and fillers (water, simple organics, tannins).

The cell wall material that is employed in accordance with the present invention is preferably sourced from plant parenchymal tissue. The source of the plant parenchymal tissue may be any plant that contains plant parenchyma cells having a cellulose skeleton.

Preferably, the source of cell wall material is selected from parenchymal tissue from fruits, roots, bulbs, tubers, seeds, leaves and combinations thereof. More preferably, the source of cell wall material is selected from citrus fruit, tomato fruit, peach fruit, pumpkin fruit, kiwi fruit, apple fruit, mango fruit, sugar beet, beet root, turnip, parsnip, maize, oat, wheat, peas and combinations thereof. Even more preferably, the source of cell wall material is selected from citrus fruit, sugar beet, sugar cane, tomato fruit and combinations thereof. A most preferred source of cell wall material is the parenchymal tissue from citrus fruit.

In a preferred embodiment, the cell wall material is citrus fibre, tomato fibre, sugar beet fibre, sugar cane fibre and combinations thereof, and even more preferably, the cell wall material is citrus fibre.

Plant cell wall material may contain primary cell wall material and/or secondary cell wall material, depending on the type of plant and the type of plant tissue. Both primary and secondary cell wall material generally comprise microfibrils.

Preferably, the delaminated cell wall material employed in accordance with the present invention comprises primary cell wall material, because, generally, for primary cell wall material less shear is required to arrive at the state of delamination and/or defibrillation that provides the fibrous preparation with its beneficial properties. Therefore, the fibrous preparation of the present invention preferably comprises at least 80 wt. %, more preferably at least 90 wt. % of primary cell wall material.

Primary cell wall material from plant tissue typically contains minor amounts of lignin, if at all. The primary cell wall material preferably comprises some lignin, like less than 10 wt. %, more preferably less than 2 wt. %, calculated on total amount of cell wall material. Preferably, the primary cell wall material consists essentially of non-lignified tissue as understood by the skilled person in the area of plant biology.

The delaminated cell wall material in the fibrous preparation preferably contains a reduced amount of water-soluble components, notably soluble and unbound sugars, protein, polysaccharides and minerals. This is suitably achieved using well known techniques including destroying the plant cell walls, heating and washing.

Fibrous Preparation of Delaminated Cell Wall Material

The fibrous preparation employed in accordance with the present invention preferably has a low water content of not more than 15 wt. %. More preferably, the fibrous preparation contains not more than 12 wt. %, most preferably not more than 10 wt. % of water.

Cellulose is typically an important constituent of the fibrous preparation. Preferably, the fibrous preparation comprises at least 30%, by weight of dry matter, more preferably at least 40%, by weight of dry matter and most preferably at least 50%, by weight of dry matter, of cellulose.

Pectin is typically present in cell walls in substantial concentrations. Pectin is typically contained in the fibrous preparation in a concentration that lies in the range of 10-50%, more preferably of 15-40% and most preferably of 20-35%, by weight of dry matter.

A large fraction of the pectin contained in the fibrous preparation is bound pectin. Typically, at least 70 wt. % of the pectin contained in the fibrous preparation is bound pectin. More preferably, at least 80 wt. % and most preferably at least 90 wt. % of the pectin in the fibrous preparation is bound pectin.

According to a particularly preferred embodiment, the fibrous preparation contains less than 75%, more preferably less than 60%, even more preferably less than 50%, yet more preferably less than 40% and most preferably less than 30% pectin by weight of cellulose. Typically, the fibrous preparation contains at least 10%, more preferably at least 20% pectin, by weight of cellulose.

Hemicellulose is typically contained in the fibrous preparation in a concentration of 10-50%, more preferably of 20-40% and most preferably of 25-35%, by weight of dry matter.

The combination of cellulose, hemicellulose and pectin, together typically constitute at least 75 wt. %, more preferably at least 85 wt. % and most preferably at least 90 wt. % of the dry matter contained in the fibrous preparation.

In typical plant tissue, the primary cell wall is formed by deposition of microfibrils at the inside of the cell wall. That is, the microfibrils are generated by protein complexes that travel in the cell membrane, thereby gradually spinning a loose web of elementary fibrils which arrange into microfibrils and fibrils that are embedded in the cell wall matrix without much alignment of the fibrils. The microfibrils are typically linked via hemicellulose tethers and embedded in a pectin matrix. The relatively loose structure of primary cell walls is what allows plant cells to grow.

When sufficient shear is applied to native cell wall material, the laminar structure of the cell wall will start coming apart, leading to a fibrous preparation of delaminated cell wall material. Preferably, no intact cell wall structures are present anymore in the fibrous preparation of delaminated cell wall material. In case even more shear is applied, the microfibrils will start coming apart from each other, leading to defibrillated cell wall material.

The cellulose in primary cell wall material generally has a relatively low degree of crystallinity. Typically, the cellulose in the fibrous preparation has an average degree of crystallinity of less than 50%. More preferably, the average degree of crystallinity of the cellulose in the fibrous preparation is less than 40%, even more preferably less than 35% and most preferably less than 30%. The table below shows the average degree of crystallinity of typical sources of cellulose microfibrils. It shows that the cellulose in primary cell wall material sourced from plant parenchymal tissue typically has a degree of crystallinity of less than 50%.

TABLE 1
Average degree of crystallinity of
cellulose (all polymorph cellulose I)

| | Average degree |
|---|---|
| Source | of crystallinity (%) |
| Tomato fibres | 32 |
| Citrus fibre (Citrus Fibre AQ + N) | 29 |
| Nata de Coco | 74 |
| Cotton | 72 |
| Wood pulp fibre (Meadwestvaco) | 61 |
| Sugar beet fibre (Nordix Fibrex) | 21 |
| Pea fibres (PF200vitacel) | 42 |
| Oat fibres (780 Sunopta) | 43 |
| Corn hull (Z-trim) | 48 |
| Sugar cane fibre (Ultracel) | 49 |

The average degree of crystallinity can be suitably determined according to the method as described in WO 2014/095323 A1.

No chemical treatment (such as hydrophobisation, or similar functionalisation or likewise derivatisation) is required to impart oil structuring capability to the fibrous preparation of the present invention. Preferably, the cellulose within the fibrous preparation has not been chemically modified. Even more preferably, the fibrous preparation has not undergone any chemical modification.

In general, if cell wall material is subjected to shear forces, this leads to structural changes. The more shear energy is applied, the more the cell wall structure is taken apart.

Delamination is one of the factors that affects the openness (and consequently the S_{BET}) of the fibrous preparation as it is used in the present invention. Without wishing to be bound by theory, it is believed that the higher the degree of delamination or defibrillation, the higher the S_{BET} is that can be obtained for the fibrous preparation. In order to realise a weight-effective porous network-like structure that maintains its porosity, it is desirable that the fibrous cell wall material is disentangled to a very high extent. This would include the disentanglement of cellulose microfibrils into relatively long yet relatively thin elementary fibrils. Therefore, the fibrous preparation of the invention preferably is a fibrous preparation of defibrillated cell wall material. Thus, the cell wall material is preferably not only delaminated but also defibrillated.

Preferably the average length of the microfibrils in the fibrous preparation is more than 1 μm and more preferably more than 5 μm.

Preferably, at least 80 wt. % of the microfibrils is smaller than 50 nm in diameter. More preferably at least 80 wt. % of the microfibrils is smaller than 40 nm in diameter, even more preferably smaller than 30 nm, even more preferably smaller than 20 nm and still more preferably smaller than 10 nm. The microfibril diameter can be suitably determined using the method as described in WO 2014/095323 A1.

The cell wall material is suitably defibrillated by subjecting it to mechanical energy and/or cavitation thereby disentangling the cellulose microfibrils in an aqueous medium as known by the skilled person. This is preferably done as part of the process for obtaining the microfibrils from the cell wall material, thus resulting in isolated defibrillated cell wall material comprising microfibrils. The required level of defibrillation preferably can also be arrived at by a succession of various such disentanglement treatments, for example by first subjecting a dispersion of the cell wall material to a high shear treatment, and at a later stage subjecting the resulting dispersion to another high shear treatment, possibly involving additional washing or similar treatment steps in between.

The fibrous preparation is suitably characterised by its specific surface area, because the favourable properties provided to the savoury concentrate by the fibrous preparation relates to its openness and therefore its specific surface area. The specific surface area can suitably be quantified by the related property S_{BET} as explained below in the examples.

The higher the specific surface area, the better the oil structuring capability of the fibrous preparation. Therefore, the fibrous preparation preferably has a specific surface area corresponding to an S_{BET} of at least 6 m²/g, more preferably at least 10 m²/g, even more preferably at least 15 m²/g, and still more preferably at least 18 m²/g. The SBET of the fibrous preparation preferably does not exceed 40 m²/g, more preferably does not exceed 35 m²/g and even more preferably does not exceed 30 m²/g.

The degree of openness of the fibrous preparation can suitably be measured by the Microfibril Availability Parameter (MAP), which is an NMR-based measure of the degree of delamination/defibrillation of the fibrous preparation as explained herein below in the examples. The fibrous preparation preferably has a Microfibril Availability Parameter (MAP) of at least 1.0 Hz, more preferably at least 1.10 Hz, even more preferably at least 1.20 Hz, still more preferably at least 1.30 Hz and yet more preferably at least 1.35 Hz, especially when the fibrous preparation is based on citrus fibre material.

Preferably, the fibrous preparation is in particulate form. The particulate form may be a direct result of the manufacturing method used to obtain the fibrous preparation, or it may be realised or modified by a size reduction treatment, including for example grinding. Therefore, the fibrous preparation is preferably ground.

The fibrous preparation may be ground before it is contacted with the oil phase. Alternatively, or even additionally, a size reduction step may also be carried out after the fibrous preparation was dispersed (at a relatively course size) in at least part of the oil phase.

The particle size of the fibrous preparation in dry form is generally hard to determine, in view of the fluffy nature of such material. However, if the fibrous preparation is dispersed in a hydrophobic liquid, e.g. a liquid triglyceride oil such as sunflower oil, the particle size distribution may readily be analysed by sieving. The weight fractions of different sizes may be determined by use of consecutive sieves of varying mesh size.

Thus, it is particularly preferred that the fibrous preparation is in particulate form and at least 70 wt. %, more preferably at least 80 wt. %, of the fibrous preparation passes a sieve with a mesh size of 500 μm, when the fibrous preparation is dispersed at 0.05-0.2 wt. % in a triglyceride oil.

Preferably, the fibrous preparation is in particulate form and not more than 30 wt. %, preferably not more than 20 wt. %, of the fibrous preparation passes a sieve with a mesh size of 125 μm, when the fibrous preparation is dispersed at 0.05-0.2 wt. % in a triglyceride oil.

A Method for the Preparation of a Savoury Concentrate

A second aspect of the invention relates to a method for the preparation of a savoury concentrate, said method comprises the combining of the following components:
a. 100 parts by weight of an oil phase comprising liquid oil;
b. 0.1-10 parts by weight of a fibrous preparation of delaminated cell wall material from plant tissue, said delaminated cell wall material containing a reduced amount of water-soluble components and having a lamellar structure of the primary cell walls that has at least partly been disrupted to release cellulose microfibrils, and said fibrous preparation comprising at least 25%, by weight of dry matter, of cellulose and having a BET specific surface area (S_{BET}) of at least 5 m²/g;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof; and

wherein the prepared savoury concentrate comprises not more than 10 wt. % water.

The embodiments that have been described herein before in the context of the savoury concentrate of the invention equally apply to this method, according to the invention, for the preparation of a savoury concentrate.

Preferably, 0.2-8 parts by weight of the fibrous preparation is combined with 100 parts by weight of oil phase. More preferably, 0.3-6 parts by weight of the fibrous preparation is combined with 100 parts by weight of oil phase. Most preferably, 0.5-4 parts by weight of the fibrous preparation is combined with 100 parts by weight of oil phase.

Preferably, 100 parts by weight of the oil phase are combined with 6-85 parts by weight of the edible salt. More preferably, 100 parts by weight of the oil phase are combined with 10-65 parts by weight of the edible salt.

Preferably, 100 parts by weight of the oil phase are combined with 6-130 parts by weight of the savoury taste giving ingredients. More preferably, 100 parts by weight of the oil phase are combined with 12-100 parts by weight of the savoury taste giving ingredients.

The prepared savoury concentrate preferably comprises 33-75 wt. %, by weight of the concentrate, of the oil phase. More preferably, the prepared savoury concentrate comprises 36-70 wt. %, by weight of the concentrate, of the oil phase. Most preferably, the prepared savoury concentrate comprises 40-65 wt. %, by weight of the concentrate, of the oil phase.

Preferably, the oil phase has a solid fat content at 20° C. (N₂₀) of 0-15% and a liquid oil content at 20° C. that equals 100%—N₂₀.

In a preferred embodiment, the oil phase is prepared by blending two or more different oils or oil fractions to obtain the oil phase. For example, a melted high melting fat component can be mixed with a liquid oil to obtain an oil phase.

The prepared savoury concentrate preferably comprises up to 9 wt. %, by weight of the concentrate, of water. More preferably, the prepared savoury concentrate comprises up to 8 wt. %, by weight of the concentrate, of water.

In a preferred embodiment 100 parts by weight of the oil phase are combined with 0.1-165 parts by weight of particulate plant material selected from herbs, spices, vegetables and combinations thereof. More preferably, 100 parts by weight of the oil phase are combined with 1-135 parts by weight of said particulate plant material. Most preferably, 100 parts by weight of the oil phase are combined with 6-115 parts by weight of said particulate plant material.

In a preferred embodiment, the method comprises the steps of:
dispersing the fibrous preparation into the oil phase to obtain a dispersion; and
combining said dispersion with the remaining components of the savoury concentrate.

In another preferred embodiment, the method comprises the steps of:
combining the fibrous preparation with the other components of the savoury concentrate, except for the oil phase, to obtain a mixture; and
combining the mixture with the oil phase.

In a preferred embodiment of the invention, the fibrous preparation is obtained by a process comprising:
i. providing cell wall material from plant tissue, said cell wall material comprising at least 15 wt. % of cellulose;
ii. delaminating said cell wall material in an aqueous medium to obtain an aqueous dispersion of delaminated cell wall material;
iii. drying the aqueous dispersion of delaminated cell wall material to obtain the fibrous preparation.

Preferably, the cell wall material from plant tissue, comprises at least 25 wt. % of cellulose, more preferably at least 40 wt. % of cellulose, and most preferably at least 50 wt. % of cellulose.

Step ii. of the process involves delaminating said cell wall material in an aqueous medium. This treatment preferably involves subjecting the cell wall material to mechanical shearing and/or cavitation.

It is preferred that the delaminated cell wall material is defibrillated. Therefore, the treatment preferably includes a high shear treatment step selected from:
high pressure homogenisation at a pressure of between 500 and 2000 bar; and
microfluidising at a pressure of between 500 and 2000 bar.

These high shear treatments are favourably combined with a shear mixing pre-treatment, for example with a mixer like a Silverson mixer. Both high pressure homogenisation and microfluidisation are well-known techniques, involving well-known equipment.

Preferably, the high shear treatment step is high pressure homogenisation as specified herein before, more preferably, it is high pressure homogenisation at a pressure of between 500 and 1000 bar, and even more preferably at a pressure of between 600 and 800 bar. It is especially preferred that the aqueous medium of step ii. comprises between 0.5 and 4 wt. % of the cell wall material and the high shear treatment step of step ii. is high pressure homogenisation at a pressure of between 600 and 800 bar.

The precise pressure and the number of passes and/or stages of the treatment—be it shear mixing, high pressure homogenisation or microfluidisation—that is required to obtain the benefits of the present invention may depend for instance on the concentration of the cell wall material present in the aqueous medium and on its level of comminution/pre-treatment before this step, but is easily determined by experimentation.

Delamination, and to a larger extent defibrillation, leads to an aqueous dispersion of the cell wall material, in which the disentangled microfibrils are distributed in the aqueous phase forming a relatively open network structure. Preferably, such a dispersion of delaminated cell wall material is dried but retains the openness of said material in the aqueous defibrillation medium. This can be arrived at by various drying techniques known to the skilled person.

A typical, but non-limiting example is rapid freezing followed by freeze-drying. Here, the dispersion is rapidly frozen first, preferably at such a rate of freezing that upon freezing the ice crystals remain small enough so as to not appreciably collapse the fibre dispersion. Next, the frozen material is freeze dried. By sublimation of the ice, the collapsing effect of capillary forces between the microfibrils in an evaporating liquid medium is avoided.

Other methods of drying that yields a preparation of cell wall material of sufficient porosity are contemplated too. These methods include for example the method as disclosed in US 2012/0090192.

Preferably, the method of the invention produces the savoury concentrate according to the invention as described herein before.

The savoury concentrate that is produced by the present method is preferably filled into a container (e.g. a jar), a pouch or a sachet.

Process of Preparing a Ready-to-Eat Savoury Product

A third aspect of the invention relates to a process of preparing a ready-to-eat savoury product, said process comprising the steps of mixing 1 part by weight of the savoury concentrate according to the present invention with 1-50 parts by weight of other edible components.

Preferably, 1 part by weight of the savoury concentrate is mixed with 1-40 parts by weight of aqueous liquid. More preferably, the present process comprises mixing 1 part by weight of the savoury concentrate with 4-20 parts by weight of aqueous liquid.

Examples of ready-to-eat savoury products that can be prepared in this manner include bouillons, soups, sauces, gravies, pan dishes or oven dishes.

According to one embodiment, the savoury concentrate is mixed with hot aqueous liquid having a temperature of at least 50° C., preferably of at least 70° C.

In accordance with another embodiment, the savoury concentrate is mixed with cold water having a temperature of less than 30° C. and the resulting mixture is subsequently heated to a temperature in excess of 70° C.

The aqueous liquid that is mixed with the savoury concentrate typically contains at least 70 wt. %, more preferably at least 80 wt. % of water.

The invention is further illustrated by means of the following non-limiting examples.

### EXAMPLES

Characterization Methods

Moisture Content

Moisture content is calculated from the weight loss measured after heating samples to 100° C. for 16 hours (in vacuum).

BET Analysis

The BET-based specific surface area (S_{BET}) was deduced from N₂ (nitrogen) adsorption and desorption isotherms using the BET (Brunauer, Emmett and Teller) theory [see e.g. S. J. Gregg, K. S. W. Sing, Adsorption, Surface area and Porosity, 2^{nd} ed. Academic Press, London, 1982]. Prior to the adsorption measurements fibre samples were degassed in vacuum at 100° C. for 16 hours. The sample cell holding the outgassed sample was evacuated and isotherms were recorded at a temperature of −196° C. (77 K) using a Micromeritics Tristar 3000 gas sorption analyzer. Portions of nitrogen gas were dosed into the sample cell and were partly adsorbed on the surface, eventually getting into equilibrium with the gas phase. In this way adsorption and desorption points could be recorded at different pressures and the adsorption and desorption isotherm could be constructed. Adsorbed nitrogen generally first forms a monolayer on the sample surface while further increase in pressure results in the formation of multilayers. In the region where monolayers and multilayers were formed, the S_{BET} was determined according to the BET theory. Adsorption points in the relative pressure range between 0.05 and 0.25 were typically used.

MAP—Sample Preparation

The Microfibril Availability Parameter is a measure for the level of activation or defibrillation of activated plant cell wall material in aqueous medium. The MAP is based on the well-known R₂ relaxation rate, determined by NMR.

For each sample, 1.2 grams of the dry fibrous preparation was dispersed in 148.8 grams of Millipore water to yield a suspension with a concentration of 0.80 wt. % of cell wall material. Dispersion was carried out using a Silverson mixer (3000 rpm, 2 minutes, fine Emulsor screen with round holes of 2 mm diameter). The pH was adjusted with 10 wt. % citric acid solution to pH 3.3±0.1. An aliquot of the sample was then transferred to an NMR measurement tube (10 mm diameter, filling height 1 cm). Reference samples for background correction are prepared as follows.

An aliquot of the resulting concentration- and pH-standardised sample was transferred directly to an 18 cm flat bottom NMR tube of 10 mm diameter at a filling height of 1 cm. In order to do a background correction, another aliquot was centrifuged (Eppendorf Centrifuge 5416) at a relative centrifugation force of 15000 for 10 min. in a 2 ml Eppendorf cup, from which the top layer without fibre (matrix) was subsequently transferred to another 18 cm flat bottom NMR tube at a filling height of 1 cm, which we refer to as a matrix reference sample. Both samples and matrix reference samples were incubated and equilibrated at 20° C. for 10 min. prior to the measurement.

MAP (R₂)—Measurements

CPMG relaxation decay data were collected for each sample and for each matrix reference sample. A Bruker MQ20 Minispec was deployed operating at a resonance frequency for protons of 20 MHz, equipped with a variable temperature probehead stabilised at 20° C. Measurements were performed using a CPMG (Carr Purcell Mayboom Gill) T2 relaxation pulse sequence to observe the relaxation decay at 20° C. (See Effects of diffusion on free precession in nuclear magnetic resonance experiments, Carr, H. Y., Purcell, E. M., Physical Review, Volume 94, Issue 3, 1954, Pages 630-638/Modified spin-echo method for measuring nuclear relaxation times, Meiboom, S., Gill, D., Review of Scientific Instruments, Volume 29, Issue 8, 1958, Pages 688-691). Data were collected with the 180° pulse spacing set to 200 μs, a recycle delay time of 30 sec., a 180°-pulse length of 5 μs (microseconds) and using 14.7 k 180°-pulses. The sequence deploys a phase cycle and complex mode detection. Prior to measurement, the suitability of the NMR system for these measurements (in terms of field homogeneity etc.) was checked by verifying that the T2* of pure water was >2 ms. The sample temperature was kept constant at 20° C. throughout each measurement.

MAP (R₂)—Data Analysis

Data were processed with Matlab using a singular value decomposition to phase correct the quadrature data (see: “Towards rapid and unique curve resolution of low-field NMR relaxation data: trilinear SLICING versus two-dimensional curve fitting”, Pedersen, H. T., Bro, R., Engelsen, S. B., Journal of Magnetic Resonance. August 2002; 157(1), Pages 141-155. DOI: 10.1006/jmre.2002.2570). The resulting, phase-corrected data were Inverse Laplace Transformed into a T₂ distribution curve using the Matlab non-negative least square constraints function lsqnonneg (Lawson, C. L. and R. J. Hanson, Solving Least Squares Problems, Prentice-Hall, 1974, Chapter 23, p. 161) with boundaries set for T₂, requiring T₂ to be in the range of 0.01 to 10 seconds and with the regularisation parameter lambda set to 0.2.

For every sample, the data were treated as follows to obtain the MAP: In the T₂ distribution curve for a particular sample, the peak corresponding to the water protons of which T₂ is averaged by exchange between the bulk water phase and the surface of the dispersed and activated cell wall material was identified. It is believed that the exchange (and resulting averaging) is due to diffusion and chemical exchange between bulk and cellulose surface sites. In the present case, the peaks of the bulk water phase were easily distinguished, as they were the peaks with the highest intensity. The peak corresponding to the bulk water phase in the matrix reference sample was similarly identified. The average T₂ value was determined by calculating the intensity-weighted average of the peak.

R₂ is defined as the inverse of this average T₂, i.e. R₂=1/T₂ and is expressed in Hz. The microfibril availability parameter MAP for a given sample is calculated as the difference between R₂ of the sample and R₂ of the matrix reference sample:

MAP=R₂(sample)−R₂(matrix reference)

Thus, MAP is a measure for the bulk water interaction with the available microfibril surface (K. R. Brownstein, C. E. Tarr, Journal of Magnetic Resonance (1969) Volume 26, Issue 1, April 1977, Pages 17-24).

Determination of Particle Size (Fibrous Preparation)

The particle size distributions of the fibrous preparations were analysed by a wet sieving method. A sample of dry fibrous preparation was dispersed in sunflower oil (fully refined and winterised, ex Unilever Rotterdam) at a concentration of 0.1 wt. % by gentle stirring. The dispersion was passed through a set of 5 steal sieves (ex Retsch, Germany), with a mesh size of 710 μm, 500 μm, 355 μm, 200 μm and 125 μm, respectively, starting with the sieve of the largest mesh size.

Evaluation Methods

Oil Exudation Assessment

The savoury concentrates were assessed for exudation of oil after 7 days of storage at ambient temperature. The lid of the savoury concentrate was removed and the savoury concentrate was subsequently turned at an angle between 135 and 180 degrees, where 180 degrees means completely upside down, for a time period of 1 minute. The oil that ran freely from the savoury concentrate was filtered using a tea sieve, and collected on a weighing plate. The amount of free oil was determined as weight percentage of the weight of the total savoury concentrate, i.e. the weight of the savoury concentrate before the weight of the free oil had been determined.

Transit Temperature Simulation

To simulate tropical transit temperature conditions, the samples were placed overnight in an oven at 60° C. The next day, after letting the samples cool down to ambient temperature, the samples were inspected visually for undesired layer formation. In case a layer of free oil was formed, the weight percentage of this layer was determined according to the method described above.

### Example 1

Fibrous preparations of cell wall material were prepared from different sources of cell wall material. Citrus fibre (Herbacel AQ Plus ex Herbafood) and sugar cane fibre (Ultracel ex Watson) were commercially sourced. Tomato fibres were prepared as described in Example 6 of WO 2014/095342 A1.

Citrus fibre and tomato fibre are primary cell wall material, sugar cane fibre is believed to be a source of both primary and some secondary cell wall material. The composition and manufacturing details of the dry fibrous preparations of samples 1 to 8 and Comparative samples A, B, and C are summarised in Table 2.

Fibre Activation

Citrus fibres (samples B, C and 1-6) were dispersed in Millipore water at a concentration of 2 wt. % and pre-activated using a high shear mixer (Silverson, 4100 rpm, 10 min, fine emulsor screen). For samples B, C, and 1, the resulting pre-activated fibres were transferred to a microfluidizer (model M-110P, Microfluidics Inc, Z-shaped chamber) and homogenised at 1200 bar (1 pass). For samples 3-6, the pre-activated fibres were transferred to a high pressure homogenizer (Niro Soavi) and homogenized at 100, 300, 500 and 800 bar (1 stage, 1 pass), respectively.

Sugar cane fibres (sample 7) were dispersed in Millipore water at a concentration of 2 wt. % and pre-activated using a high shear mixer (Silverson, 4100 rpm, 10 min, fine emulsor screen). The pre-activated fibres were transferred to a high pressure homogenizer (Niro Soavi) and homogenized at 800 bar (1 stage, 1 pass).

Tomato fibres (sample 8) were washed prior to activation to remove soluble salts and sugars. Fibre concentrate was mixed with Millipore water (ratio=1:5) and centrifuged at 10.000×g during 20 minutes (500 ml centrifuge bottles, Beckman Coulter Avanti J-26S XP centrifuge). The sediment was collected and the supernatant phase was discarded. The washing procedure was repeated one more time. The sediment (containing tomato fibres) was collected and diluted with Millipore water (ratio=1:5). The fibres were activated using a high-shear mixer (Silverson, 6000 rpm, 10 min, fine emulsor screen). Viscosity increased during shearing. No homogenization step is used in this case as homogenization is observed to reduce viscosity of the tomato fibre slurry.

Freezing of Fibre Suspensions

Liquid nitrogen-freezing (flash freezing) (samples 1-8): ca 1 kg of the suspension of activated fibres was added drop-wise to ca. 10 litres of liquid nitrogen (contained in a polystyrene box) using a 50 ml syringe. Frozen fibre pieces were removed from the liquid nitrogen and transferred to a freeze dryer.

Blast freezing (sample C): a portion of the fibre suspension was spread evenly on a (pre-cooled) stainless steel tray and cooled down to ca. −30° C. in a blast freezer (Hobart Foster Holland BV, the Netherlands). Because of air circulation, freezing in a blast freezer proceeds faster than in a freezing cabinet (at −30° C.), but not as fast as in liquid nitrogen. The suspension was kept in the blast freezer for at least 3 hours before transferring to a freeze dryer.

Drying of Fibre Suspensions

Freeze drying (samples C and 1-8): frozen fibre suspensions were freeze-dried using a Zirbus Sublimator 3×4×5 freeze dryer (Zirbus Technology GmbH, Germany) with a programmable shelf temperature. Shelves were cooled to −30° C. before samples were placed in the freeze dryer The following time-temperature profile was used: 395 minutes at −30° C., 30 minutes at −20° C., 30 minutes at −10° C., 30 minutes at 0° C., 30 minutes at 10° C., 30 minutes at 30° C. and 1830 minutes at 40° C. The condenser temperature was set to −75° C. Freeze-drying was carried out at a pressure of 0.15 mbar. Alternatively, a Labconco Freezone (6 Litre) Freeze Dry System (model: 7934031; Labconco, US) was used. In this case the temperature of the shelf was not actively controlled. The condenser temperature was −80° C. and the pressure was 0.016 mbar. Drying continued for ca. 5 days. Thus, drying was continued until the sample weight did not decrease anymore.

Air drying (sample B): fibre suspensions were air-dried using a Mitchell 10 tray drying cabinet. Air was heated to 60° C. by means of electric heating elements and circulated at an average speed of about 0.5 m/s.

Freeze- and air-dried materials were ground to a powder using an electronic coffee grinder (De'Longhi KG49).

TABLE 2

| Sample | Fibre | Activation | Freezing | Drying |
|---|---|---|---|---|
| A | Citrus | Raw material as obtained from supplier | | |
| B | Citrus | Silverson + microfluidizer | None | Air |
| C | Citrus | Silverson + microfluidizer | Blast^{(b)} | F.D.^{(a)} |
| 1 | Citrus | Silverson + microfluidizer | LN2^{(c)} | F.D. |
| 2 | Citrus | Silverson | LN2 | F.D. |
| 3 | Citrus | Silverson + 100 bar HPH^{(d)} | LN2 | F.D. |
| 4 | Citrus | Silverson + 300 bar HPH | LN2 | F.D. |
| 5 | Citrus | Silverson + 500 bar HPH | LN2 | F.D. |
| 6 | Citrus | Silverson + 800 bar HPH | LN2 | F.D. |
| 7 | Sugar cane | Silverson + 800 bar HPH | LN2 | F.D. |
| 8 | Tomato | Silverson | LN2 | F.D. |

^{(a)}F.D. = freeze drying
^{(b)}blast = blast freezer
^{(b)}LN2 = flash freezing in liquid nitrogen
^{(d)}HPH = high pressure homogenisation

Characteristics of the Dry Preparations

Moisture contents, specific surface areas (S_{BET}) and the microfibril availability parameter MAP were determined according to the characterisation methods as described herein before and are summarized in Table 3.

TABLE 3

| | Moisture | S_{BET} | MAP |
|---|---|---|---|
| Sample | (%) | (m² · g⁻¹) | (Hz) |
| A | 8.4 | 0.9 | 0.97 |
| B | 1.4 | 0.4 | 1.19 |
| C | 3.1 | 1.2 | 1.14 |
| 1 | 0.4 | 27.9 | 1.42 |
| 2 | 7.2 | 6.7 | 1.09 |
| 3 | 1.5 | 10.6 | 1.14 |
| 4 | 3.9 | 16.1 | 1.18 |
| 5 | 5.0 | 18.7 | 1.25 |
| 6 | 9.6 | 18.6 | 1.38 |
| 7 | 3.9 | 20.7 | 1.64 |
| 8 | 5.0 | 22.9 | n.d. ¹ |

¹ n.d. = not determined

BET Analysis

The N₂ adsorption and desorption isotherms obtained in the BET analysis for samples 1 to 7 were Type II isotherms, typical for non-porous and/or macroporous materials. Sample 8 shows a minor hysteresis loop, more indicative of a Type IV isotherm, suggesting that this sample is meso/macroporous.

Particle Size

The particle size analysis of sample 1 by the wet-sieving method is summarised in Table 4.

TABLE 4

| Sieve mesh size | Observation |
|---|---|
| 710 μm | Virtually all particles pass |
| 500 μm | About 10 wt. % of particles remain on this sieve |
| 355 μm | About 40 wt. % of particles remains on this sieve |
| 200 μm | About 40 wt. % of particles remains on this sieve |
| 125 μm | About 10 wt. % of particles remains on this sieve |
| Pan | Clear oil without visible particles |

Thus, at least about 70 wt. % of the particles have a size of between 200 μm and 500 μm.

### Example 2

Savoury concentrates were prepared using the following procedure:

Preparation of the Fibrous Preparation of Delaminated Cell Wall Material from Plant Tissue

Activated citrus fibres were prepared according to a similar method as described in example 1 for sample 1.

Oil Phase Preparation

In case the oil phase comprises palm oil stearin, the oil phase was prepared as follows:
A container was filled with oil at a temperature of 5° C.
A Silverson mixing head (type L4RT; fitted with 1 mm hole emulsion screen mixing head) was placed in the oil. The Silverson mixer was started operating at 3000 rpm.
Palm oil stearin was heated to over 80° C. When the heated palm oil stearin was cooled down to 65° C., it was slowly poured into the oil, close to the mixing head to optimize the mixing of the palm oil stearin with the oil. Subsequently, the mixer speed was gradually increased to 7000 rpm.
After complete addition of the molten palm oil stearin, the mixture was sheared for an additional 2 minutes at a speed of 7000 rpm.
The resulting oil blend was stored overnight a 5° C. and used the next day.

Savoury Concentrate Preparation

The savoury concentrates were prepared as follows:
If applicable, the right amount of activated citrus fibres were mixed with the oil phase manually, using a spoon.
All the dry ingredients were weighed and then mixed together for about 1 minute at speed 1, until homogeneous, in a Kenwood (type Chef classic or Chef premiere) kitchen machine, using the K-beater mixing tool.
The oil phase, including the activated citrus fibres if applicable, was added to the dry ingredients mixture and mixed for 2 minutes applying the K-beater mixing tool at speed 2 until homogeneous.
About 80 grams of the final savoury concentrate was filled and capped in plastic (PP) jars with the following dimensions:
   bottom diameter: 4.9 cm
   top diameter: 5.2 cm
   height of the container: 6.3 cm
The savoury concentrates were stored at ambient temperature.

### Example 3

Savoury concentrates were prepared on the basis of the recipes shown in Table 5, using the procedure as described in Example 2. The prepared savoury concentrates were evaluated using the evaluation methods as described herein before. The results are shown in Table 5.

TABLE 5

| | 9 | 10 | 11 | 12 | 13 | D |
|---|---|---|---|---|---|---|
| Ingredients | (wt. %) | (wt. %) | (wt. %) | (wt. %) | (wt. %) | (wt. %) |
| Sunflower oil | 45.4 | 43.9 | 0.0 | 0.0 | 0.0 | 45.7 |
| Rapeseed oil | 0.0 | 0.0 | 35.0 | 53.0 | 0.0 | 0.0 |
| Soybean oil | 0.0 | 0.0 | 0.0 | 0.0 | 65.0 | 0.0 |
| Palm oil stearin (Iodine value = 14) | 0.0 | 0.0 | 0.0 | 0.0 | 0.0 | 0.5 |
| Activated cellulose fibre (as | 0.8 | 2.3 | 2.25 | 4.0 | 6.4 | 0.0 |
| described in example 2) | | | | | | |
| Sodium chloride | 4.3 | 4.3 | 10.0 | 1.5 | 7.0 | 4.3 |
| Potassium chloride | 5.7 | 5.7 | 15.0 | 2.5 | 8.0 | 5.7 |
| Sugar | 15.7 | 15.7 | 15.7 | 15.7 | 6.7 | 15.7 |
| Powdered taste giving ingredients | 24.8 | 24.8 | 10.0 | 20.1 | 3.7 | 24.8 |
| Dried red bell pepper pieces | 2.8 | 2.8 | 10.0 | 2.8 | 2.8 | 2.8 |
| Dried basil | 0.2 | 0.2 | 1.0 | 0.2 | 0.2 | 0.2 |
| Dried parsley | 0.2 | 0.2 | 1.0 | 0.2 | 0.2 | 0.2 |
| Total (wt. %) | 100 | 100 | 100 | 100 | 100 | 100 |
| wt. % fibrous preparation based on | 1.7 | 5.0 | 6.0 | 7.0 | 9.0 | 0.0 |
| (liquid oil + fibrous preparation) | | | | | | |
| Ratio dry matter (wt.) to liquid oil | 1.2 | 1.3 | 1.9 | 0.9 | 0.5 | 1.1 |
| (wt.) | | | | | | |
| Results | | | | | | |
| wt. % oil exudation at ambient | 0 | 0 | 0 | 0 | 0 | 19 |
| temperature | | | | | | |
| Layer formation after storage at | No | No | No | No | No | n.d. ¹ |
| 60° C. | | | | | | |
| wt. % oil exudation after storage at | 0 | 0 | 0 | 0 | 0 | n.d. |
| 60° C. | | | | | | |

¹ n.d. = not determined

### Example 4

Savoury concentrates were prepared on the basis of the recipes shown in Table 6, using the procedure as described in Example 2. The prepared savoury concentrates were evaluated using the evaluation methods as described herein before. The results are shown in Table 6.

TABLE 6

| | 14 | E | F | G | H |
|---|---|---|---|---|---|
| | (wt. | (wt. | (wt. | (wt. | (wt. |
| Ingredients | %) | %) | %) | %) | %) |
| Sunflower oil | 43.9 | 40.2 | 40.2 | 40.2 | 40.2 |
| Activated cellulose fibre | 2.3 | 0.0 | 0.0 | 0.0 | 0.0 |
| (as described in example 2) | | | | | |
| Sodium chloride | 4.3 | 4.3 | 4.3 | 4.3 | 4.3 |
| Potassium chloride | 5.7 | 5.7 | 5.7 | 5.7 | 5.7 |
| Sugar | 15.7 | 15.7 | 15.7 | 15.7 | 15.7 |
| Powdered taste giving ingredients | 24.8 | 24.8 | 24.8 | 30.9 | 24.8 |
| Potato starch | 0.0 | 6.0 | 0.0 | 0.0 | 0.0 |
| Dried red bell pepper pieces | 2.8 | 2.8 | 8.9 | 2.8 | 2.8 |
| Dried basil | 0.2 | 0.2 | 0.2 | 0.2 | 6.2 |
| Dried parsley | 0.2 | 0.2 | 0.2 | 0.2 | 0.2 |
| Total (wt. %) | 100 | 100 | 100 | 100 | 100 |
| wt. % fibrous preparation | 5.0 | 0.0 | 0.0 | 0.0 | 0.0 |
| based on (liquid oil + fibrous | | | | | |
| preparation) | | | | | |
| Ratio dry matter (wt.) | 1.3 | 1.5 | 1.5 | 1.5 | 1.5 |
| to liquid oil (wt.) | | | | | |
| Results | | | | | |
| wt. % oil exudation at | 0 | 16 | 13 | 12 | 16 |
| ambient temperature | | | | | |
| Layer formation after | No | n.d. ¹ | n.d. | n.d. | n.d. |
| storage at 60° C. | | | | | |
| wt. % oil exudation after | 0 | n.d. | n.d. | n.d. | n.d. |
| storage at 60° C. | | | | | |

¹ n.d. = not determined

### Example 5

Savoury concentrates were prepared on the basis of the recipes shown in Table 7, using the procedure as described in Example 2. The prepared savoury concentrates were evaluated using the evaluation methods as described herein before. The results are shown in Table 7.

TABLE 7

| | 15 | 16 | 17 | 18 | I | J |
|---|---|---|---|---|---|---|
| Ingredients | (wt. %) | (wt. %) | (wt. %) | (wt. %) | (wt. %) | (wt. %) |
| Sunflower oil | 42.9 | 41.0 | 39.0 | 39.5 | 44.0 | 34.7 |
| Palm oil stearin (Iodine value = 14) | 2.0 | 4.0 | 6.0 | 6.5 | 2.2 | 11.6 |
| Activated cellulose fibre (as | 1.32 | 1.25 | 1.2 | 0.2 | 0.0 | 0.0 |
| described in example 2) | | | | | | |
| Sodium chloride | 4.3 | 4.3 | 4.3 | 4.3 | 4.3 | 4.3 |
| Potassium chloride | 5.7 | 5.7 | 5.7 | 5.7 | 5.7 | 5.7 |
| Sugar | 15.7 | 15.7 | 15.7 | 15.7 | 15.7 | 15.7 |
| Powdered taste giving ingredients | 24.8 | 24.8 | 24.8 | 24.8 | 24.8 | 24.8 |
| Dried red bell pepper pieces | 2.8 | 2.8 | 2.8 | 2.8 | 2.8 | 2.8 |
| Dried basil | 0.2 | 0.2 | 0.2 | 0.2 | 0.2 | 0.2 |
| Dried parsley | 0.2 | 0.2 | 0.2 | 0.2 | 0.2 | 0.2 |
| Total (wt. %) | 100 | 100 | 100 | 100 | 100 | 100 |
| wt. % fibrous preparation based on | 3.0 | 3.0 | 3.0 | 0.5 | 0.0 | 0.0 |
| (liquid oil + fibrous preparation) | | | | | | |
| Ratio dry matter (wt.) to liquid oil | 1.2 | 1.2 | 1.2 | 1.2 | 1.2 | 1.2 |
| (wt.) | | | | | | |
| Results | | | | | | |
| wt. % oil exudation at ambient | 0 | 0 | 0 | 0 | 0 | 0 |
| temperature | | | | | | |
| Layer formation after storage at | No | No | No | No | Yes | Yes |
| 60° C. | | | | | | |
| wt. % oil exudation after storage at | 0 | 0 | 0 | 0 | 3.0 | n.a. ¹ |
| 60° C. | | | | | | |

¹ n.a. = not applicable

### Example 6

Some of the fibrous preparations described in Example 1 (3—citrus; 5—citrus; 7—sugar cane; and 8—tomato) were used to prepare a savoury concentrate.

In addition, a fibrous preparation from sugar beet was applied in the same way. This fibrous preparation from sugar beet was prepared in the same way as the fibrous preparation from sugar cane fibre (sample 7 of Example 1), except that the starting material used was sugarbeet fibre (Fibrex®, ex Nordic Sugar). The specific surface area (S_{BET} value) of the fibrous preparation from sugar beet was determined to be 11.7 m²/g.

The savoury concentrates were prepared in the same way as described in Example 2 on the basis of the recipes shown in Table 8. The prepared savoury concentrates were evaluated using the evaluation methods as described herein before. The results of the evaluation are also shown in Table 8.

TABLE 8

| | 19 | 20 | 21 | 22 | 23 |
|---|---|---|---|---|---|
| | (wt. | (wt. | (wt. | (wt. | (wt. |
| Ingredients | %) | %) | %) | %) | %) |
| Vegetable oil | | | | | |
| Sunflower oil | 43.9 | | | | 45.1 |
| Rapeseed oil | | 53.0 | | | |
| Soybean oil | | | 64.4 | 64.4 | |
| Activated cellulose fibre | | | | | |
| Sugar cane (Ex. 1, #7) | 0.7 | | | | |
| Sugar beet | | 2.8 | | | |
| Citrus (Ex. 1, #5) | | | 1.6 | | |
| Citrus (Ex. 1, #3) | | | | 1.6 | |
| Tomato (Ex. 1, #8) | | | | | 0.9 |
| Sodium chloride | 4.3 | 1.5 | 7.0 | 7.0 | 4.3 |
| Potassium chloride | 5.7 | 2.5 | 8.0 | 8.0 | 5.7 |
| Sugar | 15.7 | 15.7 | 6.7 | 6.7 | 15.7 |
| Powdered taste giving ingredients | 24.8 | 20.1 | 3.7 | 3.7 | 24.8 |
| Dried red bell pepper pieces | 4.5 | 3.4 | 4.6 | 4.6 | 3 |
| Dried basil | 0.2 | 0.5 | 2.0 | 2.0 | 0.3 |
| Dried parsley | 0.2 | 0.5 | 2.0 | 2.0 | 0.3 |
| Total (wt. %) | 100.0 | 100.0 | 100.0 | 100.0 | 100.0 |
| wt. % fibrous preparation based on | 1.5% | 5.0% | 2.4% | 2.4% | 2.0% |
| (liquid oil +fibrous preparation) | | | | | |
| Ratio dry matter (wt.) to liquid | 1.3 | 0.9 | 0.6 | 0.6 | 1.2 |
| oil (wt.) | | | | | |
| Results | | | | | |
| wt. % oil exudation at ambient | 0.2 | 0 | 0 | 0 | 0 |
| temperature | | | | | |
| Layer formation after storage | No | No | No | No | No |
| at 60° C. | | | | | |
| wt. % oil exudation after storage | 0 | 0 | 0 | 0 | 0 |
| at 60° C. | | | | | |

1. A savoury concentrate comprising:
a. 33-70 wt. %, by weight of the concentrate, of an oil phase comprising liquid oil; said oil phase having a solid fat content N₂₀ at 20° C. of 0-15% and a liquid oil content at 20° C. that equals 100%—N₂₀;
b. 3-30 wt. %, by weight of the concentrate, of an edible salt selected from sodium chloride, potassium chloride and combinations thereof;
c. 1-50 wt. %, by weight of the concentrate, of savoury taste giving ingredients selected from glutamate, 5′-ribonucleotides, sucrose, glucose, fructose, lactic acid, citric acid and combinations thereof;
d. water; and
e. a fibrous preparation of delaminated cell wall material from plant tissue from which water soluble components have been removed, said delaminated cell wall material having a lamellar structure of the primary cell walls that has at least partly been disrupted to release cellulose microfibrils, and
said fibrous preparation comprising at least 25%, by weight of dry matter, of cellulose, said cellulose having an average degree of crystallinity of less than 50%; 10-50%, by weight of dry matter, of hemicellulose; 10-50%, by weight of dry matter, of pectin, at least 70% of the pectin contained in the fibrous preparation being bound pectin; at least 75%, by weight of dry matter, of the combination of cellulose, hemicellulose and pectin, and less than 75% pectin by weight of cellulose; and having a BET specific surface area (S_{BET}) of at least 5-40 m²/g;
wherein the fibrous preparation is dispersed in the oil phase in a concentration of 0.1 to 10 wt. %, by weight of the combined weight of the liquid oil and the fibrous preparation;
wherein the weight ratio of dry matter to the oil phase lies within the range of 2:1 to 0.2:1; and wherein the savoury concentrate has a total water content of up to 10 wt. %, by weight of the concentrate.

2. The savoury concentrate according to claim 1, wherein the oil phase has a solid fat content N₂₀ at 20° C. of less than 10%.

3. The savoury concentrate according to claim 1, wherein the ratio of dry matter by weight to the oil phase by weight, lies within the range of 2:1 to 0.2:1.

4. The savoury concentrate according to claim 1, wherein the sum of (i) the wt. % of the fibrous preparation, by weight of the combined weight of the liquid oil and the fibrous preparation, and (ii) the percentage of solid fat content in the oil phase at 20° C. (N₂₀), lies within the range of 1-20.

5. The savoury concentrate according to claim 1, wherein the fibrous preparation contains less than 60% pectin by weight of cellulose.

6. The savoury concentrate according to claim 1, wherein the concentrate comprises, by weight of the concentrate, up to 65 wt. % of the oil phase.

7. The savoury concentrate according to claim 1, wherein the components a) to e) together constitute at least 60 wt. % of the savoury concentrate.

8. The savoury concentrate according to claim 1, wherein the savoury concentrate comprises:
a) 40-65 wt. %, by weight of the concentrate, of the oil phase having a solid fat content at 20° C. (N₂₀) of 0-5% and a liquid oil content at 20° C. that equals 100%—N₂₀;
b) 8-20 wt. %, by weight of the concentrate, of an edible salt selected from sodium chloride, potassium chloride and combinations thereof;
c) 10-30 wt. %, by weight of the concentrate, of savoury taste giving ingredients selected from glutamate, 5′-ribonucleotides, sucrose, glucose, fructose, lactic acid, citric acid and combinations thereof;
d) up to 8 wt. %, by weight of the concentrate, of water;
e) the fibrous preparation; and
f) 5-35 wt. %, by weight of the concentrate, of particulate plant material selected from herbs, spices, vegetables and combinations thereof;
wherein the fibrous preparation is dispersed in the oil phase in a concentration of 0.5 to 4 wt. %, by weight of the combined weight of the liquid oil and the fibrous preparation; and
wherein the sum of (i) the wt. % of the fibrous preparation, by weight of the combined weight of the liquid oil and the fibrous preparation, and (ii) the percentage of solid fat content in the oil phase at 20° C. (N₂₀), lies within the range of 3-11.

9. A method for the preparation of a savoury concentrate, said method comprises the combining of the following components:
a. 100 parts by weight of an oil phase comprising liquid oil, said oil phase having a solid fat content N₂ₒ at 20′,C of 0-15% and a liquid oil content at 20° C. that equals 100%—N₂₀;
b. 0.1-10 parts by weight of a fibrous preparation of delaminated cell wall material from plant tissue from which water soluble components have been removed, said delaminated cell wall material having a lamellar structure of the primary cell walls that has at least partly been disrupted to release cellulose microfibrils, and said fibrous preparation comprising at least 25%, by weight of dry matter, of cellulose, said cellulose having an average degree of crystallinity of less than 50%; 10-50%, by weight of dry matter, of hemicellulose; 10-50%, by weight of dry matter, of pectin, at least 70% of the pectin contained in the fibrous preparation being bound pectin; at least 75%, by weight of dry matter, of the combination of cellulose, hemicellulose and pectin, and less than 75% pectin by weight of cellulose; and having a BET specific surface area (S_{BET}) of at least 5-40 m²/g;
c. 4-100 parts by weight of an edible salt selected from sodium chloride, potassium chloride and combinations thereof;
d. 1-170 parts by weight of savoury taste giving ingredients selected from glutamate, 5′-ribonucleotides, sucrose, glucose, fructose, lactic acid, citric acid and combinations thereof; and
wherein the prepared savoury concentrate comprises 33-70 wt. % of an oil phase and not more than 10 wt. % water; wherein the weight ratio of dry matter to the oil phase lies within the range of 2:1 to 0.2:1; and wherein the method comprises the steps of:
dispersing the fibrous preparation into the oil phase to obtain a dispersion; and
combining said dispersion with the remaining components of the savoury concentrate;
or the steps of:
combining the fibrous preparation with the other components of the savoury concentrate, except for the oil phase, to obtain a mixture; and
combining the mixture with the oil phase.

10. The method according to claim 9, wherein the oil phase has a solid fat content N₂₀ at 20° C. of less than 10%.

11. The method according to claim 9, wherein the fibrous preparation is obtained by a process comprising:
i. providing cell wall material from plant tissue, said cell wall material comprising at least 15 wt. % of cellulose;
ii. delaminating said cell wall material in an aqueous medium to obtain an aqueous dispersion of delaminated cell wall material;
iii. drying the aqueous dispersion of delaminated cell wall material to obtain the fibrous preparation.

12. The method according to claim 9, wherein the fibrous preparation comprises no intact cell wall structures.

13. The method according to claim 9, wherein at least 70 wt. % of the fibrous preparation passes a sieve with a mesh size of 500 μm, when the fibrous preparation is dispersed at 0.05-0.2 wt. % in a triglyceride oil.

14. The method according to claim 9, wherein the method produces a savoury concentrate comprising:
a. 33-70 wt. %, by weight of the concentrate, of an oil phase comprising liquid oil; said oil phase having a solid fat content N₂₀ at 20° C. of 0-15% and a liquid oil content at 20° C. that equals 100%—N₂₀;
b. 3-30 wt. %, by weight of the concentrate, of an edible salt selected from sodium chloride, potassium chloride and combinations thereof;
c. 1-50 wt. %, by weight of the concentrate, of savoury taste giving ingredients selected from glutamate, 5′-ribonucleotides, sucrose, glucose, fructose, lactic acid, citric acid and combinations thereof;
d. water; and
e. a fibrous preparation of delaminated cell wall material from plant tissue from which water soluble components have been removed, said delaminated cell wall material having a lamellar structure of the primary cell walls that has at least partly been disrupted to release cellulose microfibrils, and
said fibrous preparation comprising at least 25%, by weight of dry matter, of cellulose, said cellulose having an average degree of crystallinity of less than 50%; 10-50%, by weight of dry matter, of hemicellulose; 10-50%, by weight of dry matter, of pectin, at least 70% of the pectin contained in the fibrous preparation being bound pectin; at least 75%, by weight of dry matter, of the combination of cellulose, hemicellulose and pectin, and less than 75% pectin by weight of cellulose; and having a BET specific surface area (S_{BET}) of at least 5-40 m²/g;
wherein the fibrous preparation is dispersed in the oil phase in a concentration of 0.1 to 10 wt. %, by weight of the combined weight of the liquid oil and the fibrous preparation;
wherein the weight ratio of dry matter to the oil phase lies within the range of 2:1 to 0.2:1; and
wherein the savoury concentrate has a total water content of up to 10 wt. %, by weight of the concentrate.

15. A process for preparing a ready-to-eat savoury product, said process comprising the steps of mixing 1 part by weight of the savoury concentrate, according to claim 1, with 1-50 parts by weight of other edible components.
